(19) United States
(12) Patent Application Publication
(10) Pub. No.: US 2012/0143912 A1
(43) Pub. Date: Jun. 7, 2012

(54) EXTENDING LEGACY DATABASE ENGINES WITH OBJECT-BASED FUNCTIONALITY

(75) Inventors: John C. Horton, Saint Paul, MN (US); Michael J. Hill, Vadnais Heights, MN (US)

(73) Assignee: Unisys Corp., Blue Bell, PA (US)

(21) Appl. No.: 12/960,512

(22) Filed: Dec. 5, 2010

(51) Int. Cl. G06F 17/30

(52) U.S. Cl. 707/774; 707/769; 707/E17.014

(57) ABSTRACT

Legacy database engines may be extended through the use of callback extension handlers on the client. For example, regular expression matching and arbitrary user-functions may be implemented in a legacy database engine without replacing the engine. A pattern string may be provided to the legacy database engine by a client with a pattern matching prefix. When the legacy database engine encounters the prefix, the database engine executes a callback to the client with a value from the database for pattern matching. The client performs the pattern matching through, for example, regular expressions, and returns a match status to the database engine. The process may be repeated for several rows of a table in the database and a dataset compiled by the database engine and returned to the client.

### TECHNICAL FIELD

The instant disclosure relates to computer programs. More specifically, the instant disclosure relates to databases.

### BACKGROUND

Legacy database engines and their associated applications continue to serve mission critical roles in many organizations. However, legacy database engines lack some newer features important to users of the database engines. For example, one feature missing from many legacy database engines is regular expression matching. Replacing or rewriting the legacy database engines with modern object-oriented languages and tools may be costly and disruptive to an organization's operations. For example, the database engine may be taken offline to install and debug the replaced or rewritten code.

One conventional solution to make new functionality available to users of a legacy database engine is to replace the legacy database engine and the applications that use it. As discussed above, this can be a costly and disruptive solution.

Another conventional solution is to use the legacy database engine but replace the applications that access the legacy database engine. That is, the application could retrieve all possible records and then reprocess the records to refine the record set. This solution is inefficient because data is fetched from the database that is not needed and additional computations are performed on the client.

### SUMMARY

According to one embodiment, a method includes receiving a callback from a database engine having an index pointer and a column value pointer. The method also includes calling an extension handler corresponding to the index pointer with the column value pointer. The method further includes returning a match status to the database engine.

According to another embodiment, a computer program product includes a computer-readable medium having code to receive a pattern string for a first column of a table of a database. The medium also includes code to identify a pattern match extension prefix in the pattern string. The medium further includes code to, when the pattern match extension prefix is located in the pattern string, call an extension callback function with an index pointer and a column value pointer. The medium also includes code to, when the pattern match extension prefix is located in the pattern string, receive a match status from the extension callback function.

According to yet another embodiment, a method includes receiving a pattern string for a first column of a table of a database. The method also includes identifying a pattern match extension prefix in the pattern string. The method further includes, when the pattern match extension prefix is located in the pattern string, calling an extension callback function with an index pointer and a column value pointer and receiving a match status from the extension callback function.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an information system according to one embodiment of the disclosure.

FIG. 2 is block diagram illustrating a data management system configured to store databases, tables, and/or records according to one embodiment of the disclosure.

FIG. 3 is a block diagram illustrating a server according to one embodiment of the disclosure.

FIG. 4 is a flow chart illustrating an exemplary method for extending legacy database engines with object-based functionality according to one embodiment of the disclosure.

FIG. 5 is source code illustrating an exemplary client application according to one embodiment of the disclosure.

FIG. 6 is a flow chart illustrating an exemplary method for processing a callback according to one embodiment of the disclosure.

FIG. 7 is a block diagram illustrating an exemplary table for matching callback functions according to one embodiment of the disclosure.

FIG. 8 is a call flow diagram illustrating an exemplary method of client scripting with a legacy database engine according to one embodiment of the disclosure.

### DETAILED DESCRIPTION

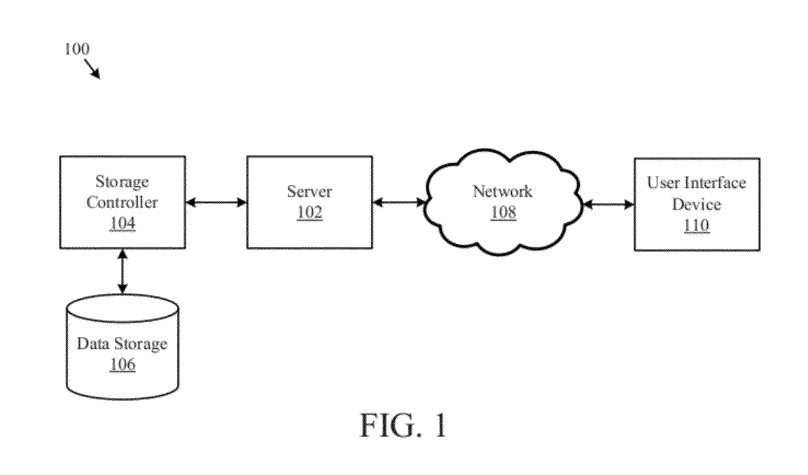

FIG. 1 illustrates one embodiment of a system 100 for an information system. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to store databases, pages, tables, and/or records. Additionally, count operation scripts on the server 102 may access data stored in the data storage device 106 via a Storage Area Network (SAN) connection, a LAN, a data bus, or the like. The data storage device 106 may include a hard disk, including hard disks arranged in an Redundant Array of Independent Disks (RAID) array, a tape storage drive comprising a magnetic tape data storage device, an optical storage device, or the like. The data may be arranged in a database and accessible through Structured Query Language (SQL) queries, or other data base query languages or operations.

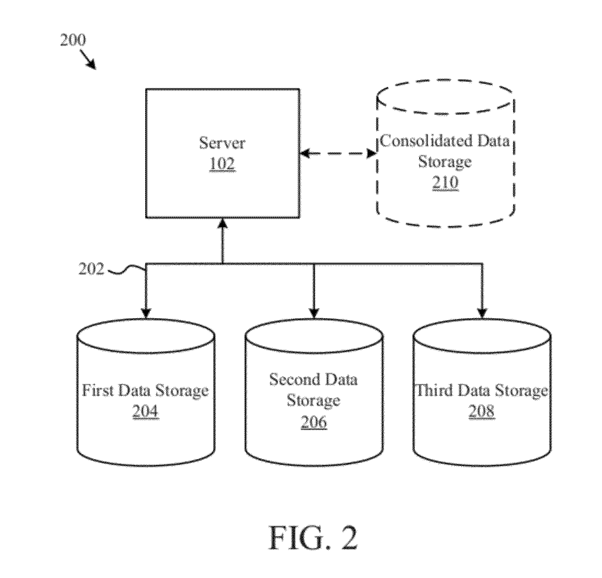

FIG. 2 illustrates one embodiment of a data management system 200 configured to provide access to databases, tables, and/or records. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data from the storage devices 204, 206. The server 102 may store consolidated data sets in a consolidated data storage device 210. In such an embodiment, the server 102 may refer back to the consolidated data storage device 210 to obtain a set of records. Alternatively, the server 102 may query each of the data storage devices 204, 206, 208 independently or in a distributed query to obtain the set of data elements. In another alternative embodiment, multiple databases may be stored on a single consolidated data storage device 210.

In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

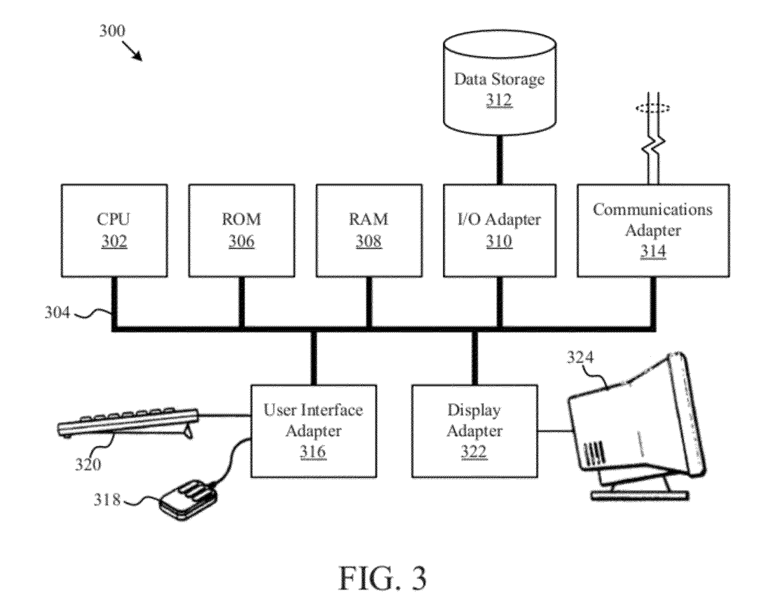

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application such as databases, tables, and/or records. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application. For example, the display adapter 322 may display menus allowing an administrator to input pattern strings on the server 102 through the user interface adapter 316.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

Extension of legacy database engines, rather than replacement, may provide an administrator of a database engine the option of providing new capability to the legacy database engine without the costs and downtime associated with replacing the database engine. For example, additional functionality may be provided through callback functions. That is, a legacy database engine may identify flags in a request identifying a callback function is indicated. When the flag is identified the legacy database engine may send information from the database along with a query to the client. After the client performs matching or another calculation a result is returned to the legacy database engine. Although callback functions located on a client are described, the callback functions may also be located on separate computer systems or in another application located with the legacy database engine.

According to one embodiment, callback functions may be used to implement regular expression matching in a legacy database engine. For example, legacy database engines may only offer simple pattern matching in queries limited to case sensitivity and simple wildcards. Implementing regular expressions in a legacy database engine may allow a client access to more sophisticated matching, including multiple patterns in a single expression.

According to another embodiment, callback functions may be used to implement arbitrary client object methods in a legacy database engine. For example, open-ended query pattern matching may allow a client to design application-specific matching functions written in the client's programming language. The client may also modify database content during pattern matching operations. Client object methods may be advantageous when normalizing data into a format desired by the client such as dates, addresses, and telephone numbers.

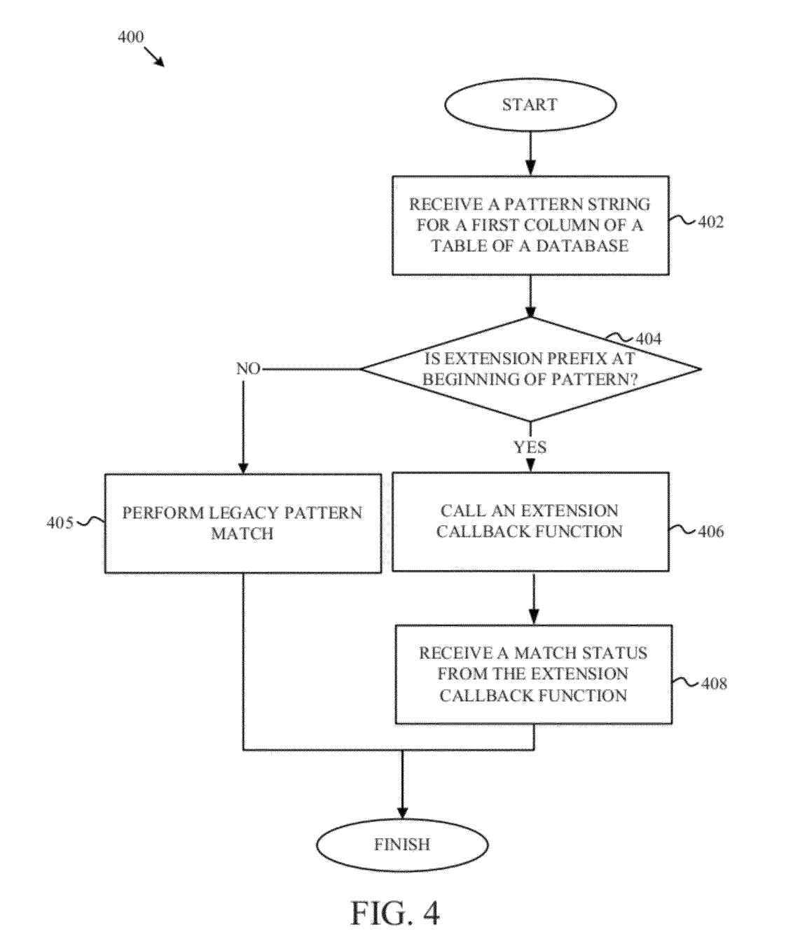

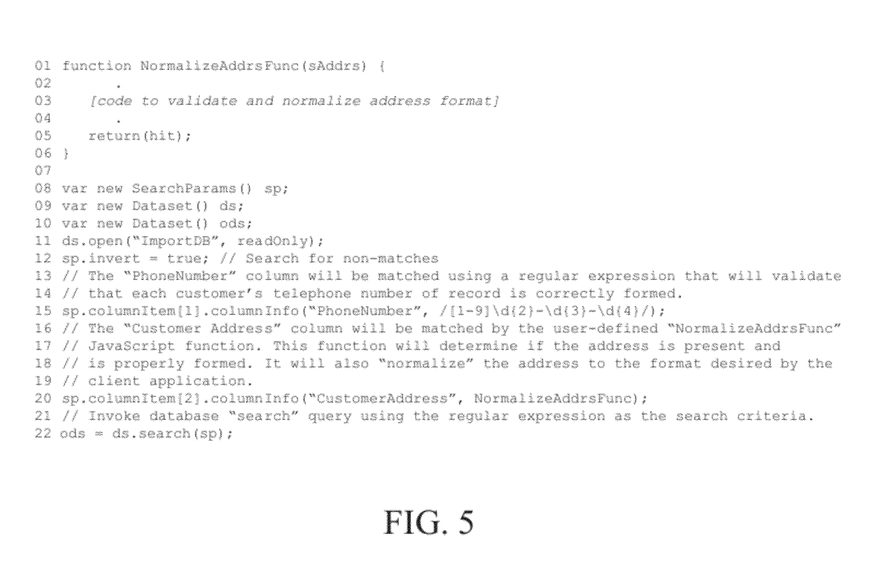

FIG. 4 is a flow chart illustrating an exemplary method for extending legacy database engines with object-based functionality according to one embodiment of the disclosure. A method 400 begins at block 402 with receiving a pattern string from a client for a first column to be matched of a table of a database. The pattern string may include a match extension prefix indicating the legacy database engine should call an extension callback function to handle the pattern string. According to one embodiment, a client specifies the pattern string through a columnInfo method. An example script illustrating client code is shown in FIG. 5. Lines 15 and 20 include calls to the columnInfo method. The pattern strings may be passed to the legacy database engine with a search process, such as the search process illustrated on line 22 of FIG. 5.

Referring back to FIG. 4, the method 400 continues to block 404 with identifying if a pattern match extension prefix is located at the beginning of the pattern string. According to one embodiment, the match extension prefix may be the characters “0xFF, 0xFF.” If the match extension prefix is not present at the beginning of the pattern string, the legacy database engine may perform legacy pattern matching on the pattern string at block 405. However, if the match extension prefix is present, the match extension prefix may be followed by an array index for identifying a particular extensions callback function.

When the pattern match extension prefix is located in the pattern string, the method 400 continues to block 406 with calling an extension callback function with an index pointer and a column value pointer. The index pointer identifies to the client a particular extension callback function for handling the data pointed to by the column value pointer. The column value pointer may point to a value retrieved by the legacy database engine for pattern matching by an extension callback function of the client.

The method 400 continues to block 408 with receiving a match status from the extension callback function. After the client performs pattern matching according to the index pointer and the column value pointer, a match status is received by the legacy database engine. The match status may be either a true or false indicating a match was identified or not identified or vice versa. Regardless of whether the column match was performed by the legacy database functionality or extended functionality, the database engine's query operation returns to its normal path and the match status is handled accordingly.

The blocks 402, 404, 406, and 408 may be repeated for several rows in a table of the legacy database engine. Thus, the pattern string is compared to a column in each row of the table and a match status for each row may be recorded. After some or all rows of the table are searched a set of search results may be returned to the client.

According to one embodiment, more than one column may be pattern matched for each row of the table. For example, the legacy database engine may receive a second pattern string for a second column of the table. The second pattern string may be tested for presence of a pattern match extension prefix. If the prefix is present a second extension callback function is called for each row of the table being compared.

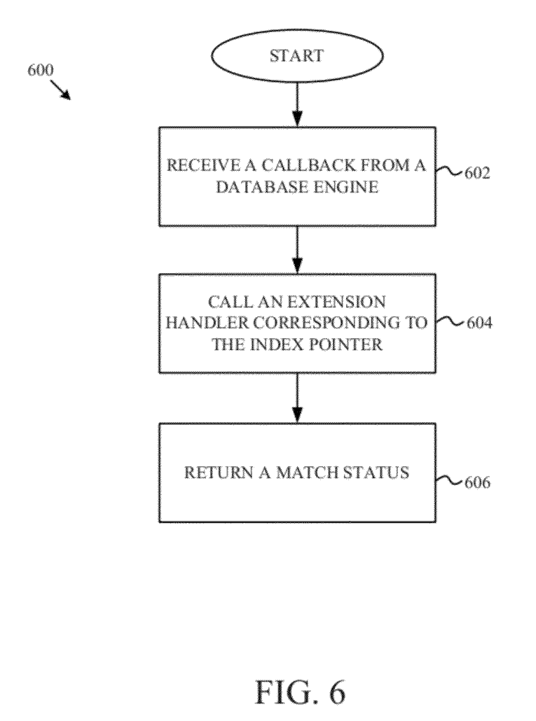

FIG. 6 is a flow chart illustrating an exemplary method for processing a callback according to one embodiment of the disclosure. At block 602 a client receives a callback from a legacy database engine having an index pointer and a column value pointer. At block 604 the client calls an extension handler function corresponding to the value pointed to by the value pointer. Although pointers are passed to the client through the database callback, values may instead be passed to the client.

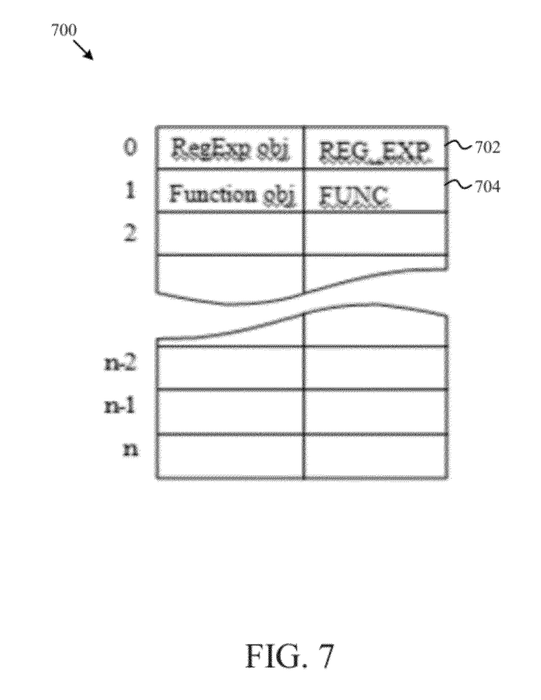

The client may identify an extension handler to handle the callback request through a match callback table. FIG. 7 is a block diagram illustrating an exemplary table for matching callback functions according to one embodiment of the disclosure. A match callback table 700 includes rows 702 and 704. The match callback table 700 may be created when the client calls the search function described above with reference to FIG. 5. For example, the search function may recognize a regular expression as the match criteria specified in line 15 of FIG. 5 and place a regular expression instance reference (RegExp obj) into the row 702 of the table 700 and a callback handler type indicator (REG_EXP) into the row 702. Similarly, the search function may recognize an arbitrary client object method specified in line 20 of FIG. 5 and place the user-defined function NormalizeAddrsFunc into row 704 of the table 700.

Referring back to FIG. 6, at block 606 a match status is returned to the legacy database engine after the extension handler completes. The match status may be a true or false indicating a result of pattern matching.

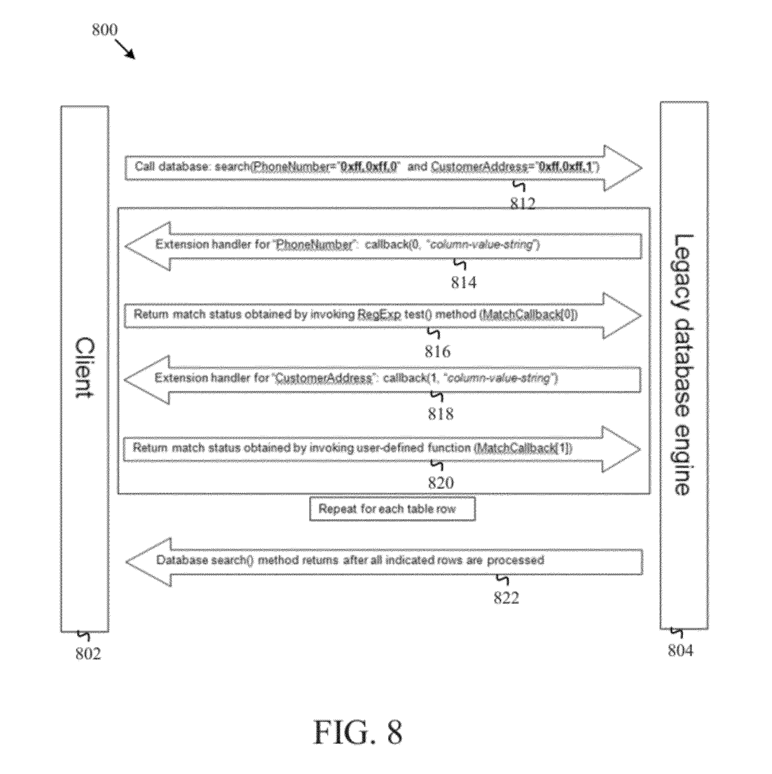

FIG. 8 is a call flow diagram illustrating an exemplary method of client scripting with a legacy database engine according to one embodiment of the disclosure. A call flow 800 begins at call 812 with a client 802 calling a legacy database engine 804 with pattern matching strings for PhoneNumber and CustomerAddress. The PhoneNumber and CustomerAddress pattern matching strings includes the pattern match prefix extension “0xFF, 0xFF” followed by an index pointer for identifying a callback extension handler. At call 814 the legacy database engine calls an extension handler on the client for handling the PhoneNumber pattern matching and passes an index pointer and a column value string containing a column value from the first row of the table. At call 816 the client 802 returns a match status to the legacy database engine 804.

At call 818 the legacy database engine 804 calls an extension handler on the client 802 for pattern matching on the CustomerAddress column of the first row. At call 820 the client 802 returns a match status to the legacy database engine 804. The calls 814, 816, 818, and 820 may be repeated for each row of the table tested by the legacy database engine 804. At call 822 the legacy database engine 804 compiles a dataset of all indicated rows of the tables and returns the dataset to the client 802.

The methods described above allow extension of a legacy database engine without the costs and downtime associated with replacing the legacy database engine with a new database engine. The extensions described may operate independent of the operating system, hardware, or programming language of the client or the legacy database engine. If the database engine and the database client application reside in different processes, the methods may operate through any available inter-process communication such as, for example, shared memory, or network sockets. Additionally, the callback handler extensions may be adapted for a number of functions such as, for example, updating the database, normalizing the format of retrieved column values, or performing other calculations and operations not supported by the legacy database engine.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a first pattern string for a first column of a table of a database;
identifying a pattern match extension prefix in the first pattern string; and
when the pattern match extension prefix is located in the first pattern string:
calling a first extension callback function with an index pointer and a column value pointer; and
receiving a match status from the extension callback function.

2. The method of claim 1, in which when the pattern match extension prefix is not located in the first pattern string performing normal legacy pattern matching.

3. The method of claim 1, in which the index pointer specifies a particular extension callback function and in which the column value pointer is a pointer to a memory location storing data from the first column of the table for at least one row.

4. The method of claim 1, in which the receiving step, the identifying step, and the calling step are repeated for several rows in the table.

5. The method of claim 4, further comprising returning the rows of the table for which a positive match status is received from the first extension callback function.

6. The method of claim 1, in which the first pattern string is received from a client and in which the first extension callback function is located on the client.

7. The method of claim 1, in which the database is stored on a database server executing a legacy database engine.

8. The method of claim 1, in which identifying the pattern match extension prefix comprises identifying a hexadecimal FF value.

9. The method of claim 1, further comprising:
receiving a second pattern string for a second column of the table;
identifying the pattern match extension prefix in the second pattern string; and
when the pattern match extension prefix is located in the second pattern string:
calling a second extension callback function with a second index pointer and a second column value pointer; and
receiving a second match status from the second extension callback function.

10. A computer program product, comprising:
a computer-readable medium comprising:
code to receive a pattern string for a column of a table of a database;
code to identify a pattern match extension prefix in the pattern string; and
code to, when the pattern match extension prefix is located in the pattern string, call an extension callback function with an index pointer and a column value pointer; and
code to, when the pattern match extension prefix is located in the pattern string, receive a match status from the extension callback function.

11. The computer program product of claim 10, in which the medium further comprises code to, when the pattern match extension prefix is not located in the pattern string, perform normal legacy pattern matching.

12. The computer program product of claim 10, in which the medium further comprises code to repeat the code to receive, the code to identify, and the code to call for several rows in the table.

13. The computer program product of claim 10, in which the medium further comprises code to return the rows of the table for which a positive match status is received from the extension callback function.

14. The computer program product of claim 10, in which the medium further comprises code to access a legacy database engine.

15. The computer program product of claim 10, in which the code to receive a pattern string receives a pattern string from a client.

16. The computer program product of claim 15, in which the code to call the extension callback function calls the extension callback function located on the client.

17. A method, comprising:
receiving a callback from a database engine having an index pointer and a column value pointer;
calling an extension handler corresponding to the index pointer with the column value pointer; and
returning a match status to the database engine.

18. The method of claim 17, further comprising locating the corresponding extension handler for the callback by accessing a row of a callback table corresponding to the index pointer.

19. The method of claim 17, in which the extension handler is at least one of a regular expression object and a function object.

20. The method of claim 17, in which the database engine is legacy database engine.
